(19) United States
(12) Patent Application Publication
(10) Pub. No.: US 2016/0212489 A1
(43) Pub. Date: Jul. 21, 2016

(54) METHOD, ELECTRONIC DEVICE, AND COMPUTER PROGRAM PRODUCT

(71) Applicants: Kabushiki Kaisha Toshiba, Tokyo (JP); Toshiba Lifestyle Products & Services Corporation, Tokyo (JP)

(72) Inventor: Nobuyuki SUZUKI, Hino Tokyo (JP)

(21) Appl. No.: 14/976,175

(22) Filed: Dec. 21, 2015

(30) Foreign Application Priority Data
Jan. 15, 2015 (JP) 2015-006172

(51) Int. Cl. H04N 21/482; H04N 21/426; H04N 21/462

(52) U.S. Cl. CPC H04N 21/4821; H04N 21/4622; H04N 21/4263

(57) ABSTRACT

According to one embodiment, a method performed by an electronic device includes: receiving first information on programs of a plurality of first channels via a broadcast signal; receiving second information on programs of a plurality of second channels from a server on a network; and outputting a list when the electronic device is connected to the network and one or more third channels common to the first channels and the second channels are present. The list includes: information on programs of the third channels in the second information; and information on programs of fourth channels other than the third channels in the first information.

### CROSS-REFERENCE TO RELATED APPLICATIONS

This application is based upon and claims the benefit of priority from Japanese Patent Application No. 2015-006172, filed Jan. 15, 2015, the entire contents of which are incorporated herein by reference.

### FIELD

Embodiments described herein relate generally to a method, an electronic device, and a computer program product.

### BACKGROUND

Conventionally, there has been known a technique for outputting a program list based on program information acquired via the Internet.

There are cases where the program information acquired via the Internet, unlike program information superimposed on broadcast signals, contain program information on channels that are not actually received as broadcast signals.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating a schematic configuration of a television device according to an embodiment;

FIG. 2 is an exemplary block diagram illustrating an internal configuration of the television device in the embodiment;

FIG. 3 is an exemplary diagram illustrating an example of a correspondence relationship between a first list and a second list used by the television device in the embodiment;

FIG. 4 is an exemplary diagram illustrating an example of a display list used by the television device in the embodiment;

FIG. 5 is an exemplary diagram illustrating an example of a program guide displayed on the television device in the embodiment;

FIG. 6 is an exemplary flowchart illustrating processing performed by the television device in the embodiment;

FIG. 7 is an exemplary flowchart illustrating details of processing performed by the television device to generate the display list, in the embodiment; and

FIG. 8 is an exemplary flowchart illustrating details of processing performed by the television device to check whether the second list contains data that matches data in the first list, in the embodiment.

### DETAILED DESCRIPTION

In general, according to one embodiment, a method performed by an electronic device comprises: receiving first information on programs of a plurality of first channels via a broadcast signal; receiving second information on programs of a plurality of second channels from a server on a network; and outputting a list when the electronic device is connected to the network and one or more third channels common to the first channels and the second channels are present. The list comprises: information on programs of the third channels in the second information; and information on programs of fourth channels other than the third channels in the first information.

Embodiments will be described below based on the drawings.

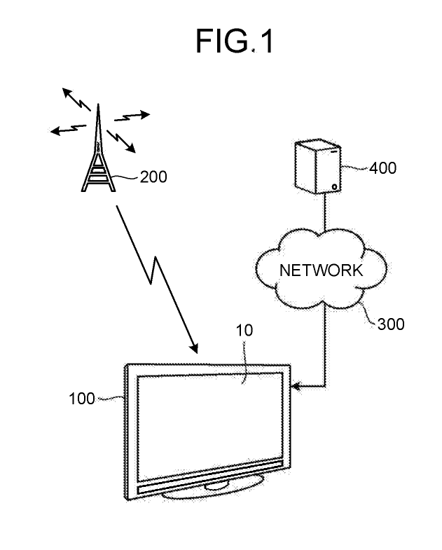

First, with reference to FIG. 1, a schematic configuration of a television device 100 according to an embodiment will be described. The television device 100 is an example of an “electronic device”.

As illustrated in FIG. 1, the television device 100 is configured to receive a broadcast signal from a broadcast station 200. The television device 100 comprises a display 10 configured to display images, such as still images or moving images, based on the broadcast signal received from the broadcast station 200. Further, the television device 100 is connected to a program information server 400 via a network 300, such as the Internet.

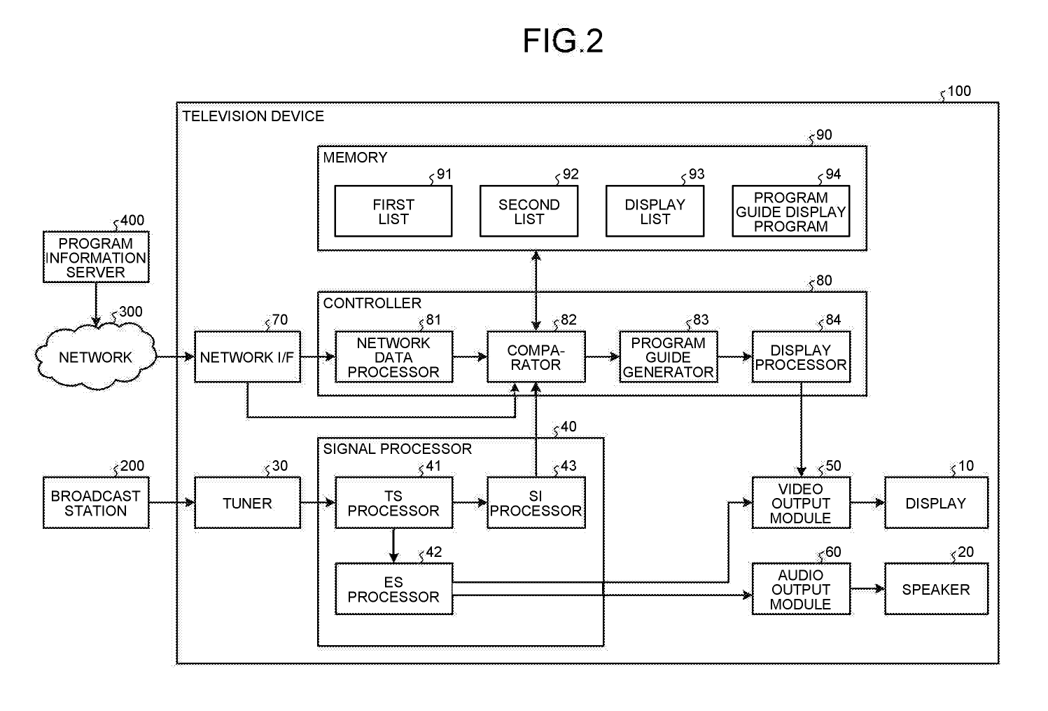

With reference to FIG. 2 to FIG. 5, an internal configuration of the television device 100 will be described in detail below.

As illustrated in FIG. 2, the television device 100 comprises the display 10, a speaker 20, a tuner 30, a signal processor 40, a video output module 50, an audio output module 60, a network interface (I/F) 70, a controller 80, and a memory 90. The controller 80 is an example of a “hardware processor”.

The display 10 is a video output device configure to output video. The speaker 20 is an audio output device configured to output audio.

The tuner 30 is a device configured to receive a broadcast signal from the broadcast station 200 via an antenna (not illustrated) or the like. On the broadcast signal, program information on a plurality of channels provided by the broadcast station 200 is superimposed. The broadcast signal is demodulated as a transport stream (TS) by a demodulator (not illustrated) or the like.

The signal processor 40 is a device configured to perform various kinds of signal processing on the broadcast signal received from the broadcast station 200. The signal processor 40 comprises a TS processor 41, an ES processor 42, and a SI processor 43.

The TS processor 41 is configured to separate a TS into an elementary stream (ES) containing video and audio and service information (SI) indicating arrangement of programs in the TS. The TS processor 41 is configured to output the ES to the ES processor 42 and output the SI to the SI processor 43.

The ES processor 42 is configured to perform signal processing on the ES input from the TS processor 41, to output a video signal to the video output module 50, and to output an audio signal to the audio output module 60. The video output module 50 is configured to output the video signal input from the ES processor 42 to the display 10. The audio output module 60 is configured to output the audio signal input from the ES processor 42 to the speaker 20.

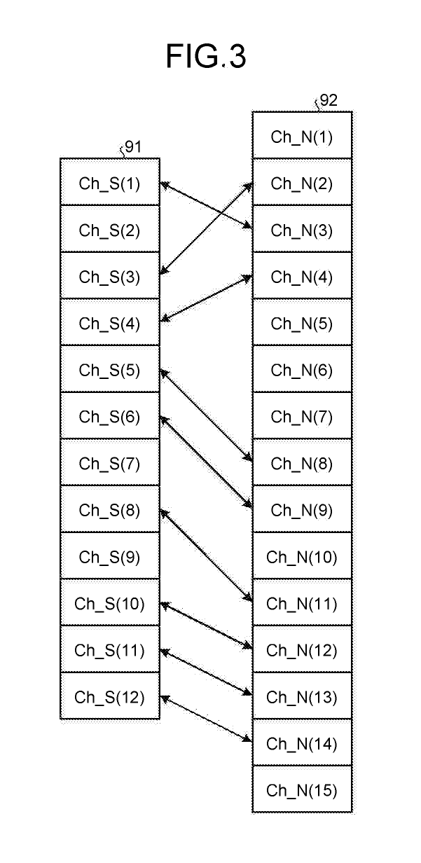

The SI processor 43 is configured to extract program information from the SI input from the TS processor 41 and to generate a first list 91 (see the left side in FIG. 3). In the first list 91 illustrated on the left side in FIG. 3, pieces of data Ch_S (1) to Ch_S (12) of 12 channels are registered, for example. Each piece of the data contains a channel ID, or the like, for example.

Referring back to FIG. 2, the network I/F 70 is connected to the network 300. The network I/F 70 is a device configured to receive pieces of program information on a plurality of channels from the program information server 400 on the network 300.

The controller 80 comprises a central processing unit (CPU) or the like configured to control each of the components of the television device 100. The memory 90 comprises a read only memory (ROM), a random access memory (RAM) , or the like. The memory 90 is configured to store therein various computer programs, various kinds of data, and the like used in various kinds of processing performed by the controller 80. In FIG. 2, the first list 91, a second list 92, and a display list 93 are illustrated as examples of the data stored in the memory 90, and a program guide display program 94 is illustrated as an example of the computer program stored in the memory 90.

The controller 80 according to the embodiment comprises, as a functional configuration, a network data processor 81, a comparator 82, a program guide generator 83, and a display processor 84. These modules maybe implemented by cooperation of software and hardware, or may be realized by only hardware. Namely, in the embodiment, the network data processor 81, the comparator 82, the program guide generator 83, and the display processor 84 may be generated on the RAM of the memory 90 by the CPU of the controller 80 reading the program guide display program 94 from the ROM of the memory 90 and executing the program guide display program 94. Alternatively, dedicated hardware (a circuit) corresponding to each of the network data processor 81, the comparator 82, the program guide generator 83, and the display processor 84 may be provided in the television device 100.

The network data processor 81 is configured to process data received via the network I/F 70. For example, the network data processor 81 is configured to generate the second list 92 (see the right side in FIG. 3) based on the program information received from the program information server 400 via the network I/F 70. In the second list 92 illustrated on the right side in FIG. 3, pieces of data Ch_N(1) to Ch_N(15) of 15 channels are registered, for example.

In general, it is often the case that the program information received via the network I/F 70 contains a greater amount of information than the program information received via the tuner 30. In contrast, not all of the channels in the program information received via the network I/F 70 match the channels in the program information received via the tuner 30. Therefore, in the case of providing a user with a program guide of the channels that can be displayed by the television device 100, it is desirable to put the program information received via the network I/F 70 on the program guide with regard to the program information on a channel that can be received via the network I/F 70, and put the program information received via the tuner 30 on the program guide with regard to the program information on a channel that cannot be received via the network I/F 70.

Therefore, in the embodiment, the comparator 82 is configured to compare the first list 91 input from the SI processor 43 with the second list 92 input from the network data processor 81. More specifically, the comparator 82 is configured to sequentially compare pieces of data in the first list 91 with pieces of data in the second list 92 one by one, and check whether the second list 92 contains a piece of data with a channel ID that matches a channel ID of a piece of data in the first list 91.

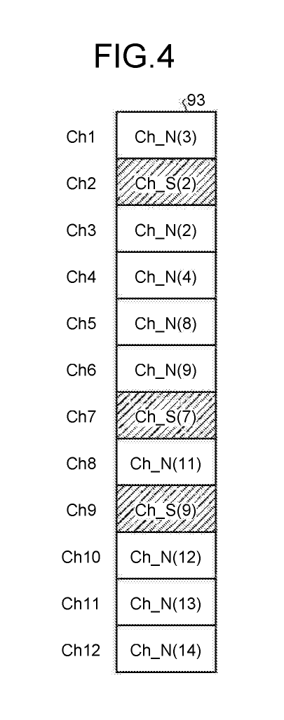

The comparator 82 is configured to output a comparison result to the program guide generator 83. The program guide generator 83 is configured to generate the display list 93 (see FIG. 4) based on the comparison result input from the comparator 82. FIG. 4 illustrates an example of the display list 93 generated based on the first list 91 and the second list 92 in FIG. 3.

In the example in FIG. 3, the channel IDs of the pieces of data Ch_S(1), Ch_S(3), Ch_S(4), Ch_S(5), Ch_S(6), Ch_S(8), Ch_S(10), Ch_S(11), and Ch_S(12) in the first list 91 match the channel IDs of the pieces of data Ch_N(3), Ch_N(2), Ch_N(4), Ch_N(8), Ch_N(9), Ch_N(11), Ch_N(12), Ch_N(13), and Ch_N(14) in the second list 92, respectively. In contrast, the second list 92 does not contain pieces of data with the channel IDs that match the channel IDs of the other pieces of data Ch_S(2), Ch_S(7), and Ch_S(9) in the first list 91. Therefore, as illustrated in FIG. 4, the pieces of data Ch_N(3), Ch_S(2), Ch_N(2), Ch_N(4), Ch_N(8), Ch_N(9), Ch_S(7), Ch_N(11), Ch_S(9), Ch_N(12), Ch_N(13), and Ch_N(14) are registered in the display list 93 generated based on the first list 91 and the second list 92 in FIG. 3. Meanwhile, hatching in FIG. 4 indicates that the pieces of data in hatched blocks are based on the first list 91. Further, letters Ch1 to Ch12 on the left side of the display list 93 in FIG. 4 indicate examples of channel numbers that are used when the display list 93 is displayed, as a program guide, on the display 10.

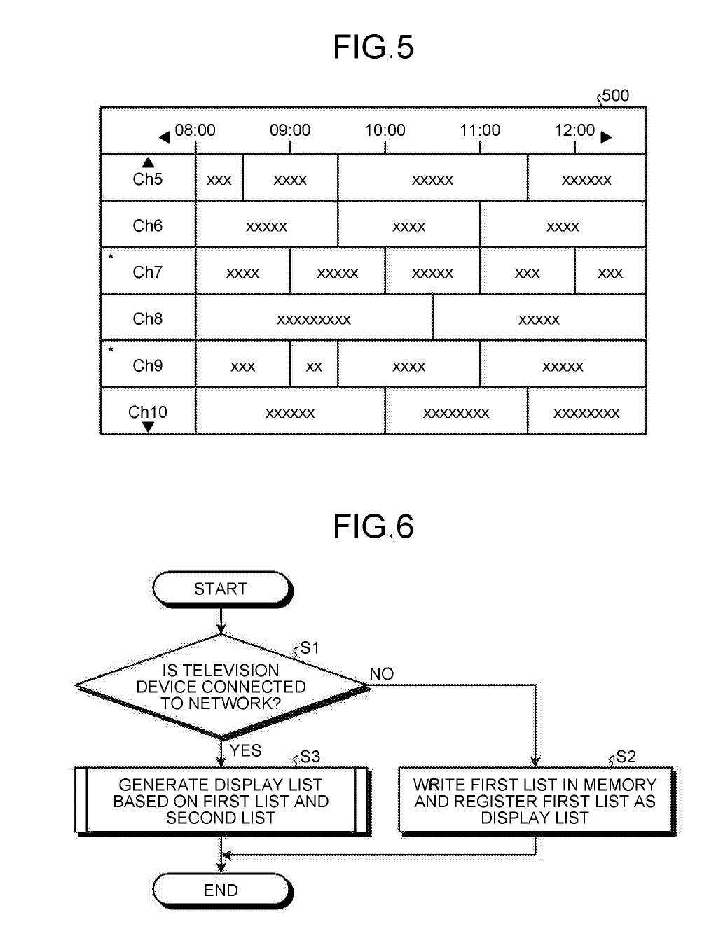

The program guide generator 83 is configured to output the generated display list 93 to the display processor 84. The display processor 84 is configured to output a control signal to the video output module 50 in order to cause the display 10 to display a program guide 500 (see FIG. 5) based on the display list 93, on the basis of the display list 93 input from the program guide generator 83.

FIG. 5 is a diagram illustrating an example of the program guide 500 based on the display list 93 in FIG. 4. The program guide 500 in the embodiment is displayed in a display style, in which it is possible to distinguish whether the program information is received by being superimposed on a broadcast signal, that is, whether the program information is based on the first list 91 received via the tuner 30. For example, in the example in FIG. 5, display or non-display of an “*” mark enables the above described distinction. Specifically, in the program guide 500 in FIG. 5, it is possible to visually recognize that the channels Ch7 and Ch9 with the “*” marks are channels for which the program information has been acquired based on the first list 91, that is, channels for which the program information has not been received from the program information server 400 via the network 300. Meanwhile, in the embodiment, the display style is not limited to display or non-display of the “*” mark, but any display style is applicable as long as the above described distinction is possible.

Further, the program guide 500 in the embodiment is displayed, on the display 10, as a two-dimensional program guide, in which channel information (such as channel numbers) is arranged along one of a row direction and a column direction and time information is arranged along the other one of the row direction and the column direction. For example, in the example in FIG. 5, the channel numbers are arranged in a longitudinal direction (column direction) and the time information is arranged in a horizontal direction (row direction) ; however, in the embodiment, the row direction and the column direction may be interchanged. Further, in the example in FIG. 5, a display range of the channel numbers is set to from Ch5 to Ch10, and a display range of the time information is set to 08: 00 to 12: 00; however, these display ranges may be changed through user' s operation using a remote controller (not illustrated) or the like.

Meanwhile, in the embodiment, the comparator 82 is configured to perform the above described comparison only when the television device 100 is connected to the network 300. Specifically, the comparator 82 is configured to perform the above described comparison only when receiving, from the network I/F 70, a notice indicating that the television device 100 is connected to the network 300. Therefore, in the embodiment, when the television device 100 is not connected to the network 300, the display 10 displays a program guide based on only the first list 91 received via the tuner 30.

Next, with reference to FIG. 6, processing performed by the television device 100 when executing the program guide display program 94 will be described.

In the processing flow of FIG. 6, at 51, the comparator 82 determines whether the television device 100 is connected to the network 300. Specifically, the comparator 82 determines whether a notice indicating that the television device 100 is connected to the network 300 is received from the network I/F 70.

At S1, when it is determined that the television device 100 is not connected to the network 300, the processing proceeds to S2. At S2, the comparator 82 writes the first list 91 in the memory 90 based on the program information received via the tuner 30, and registers the first list 91 as the display list 93. The processing then ends.

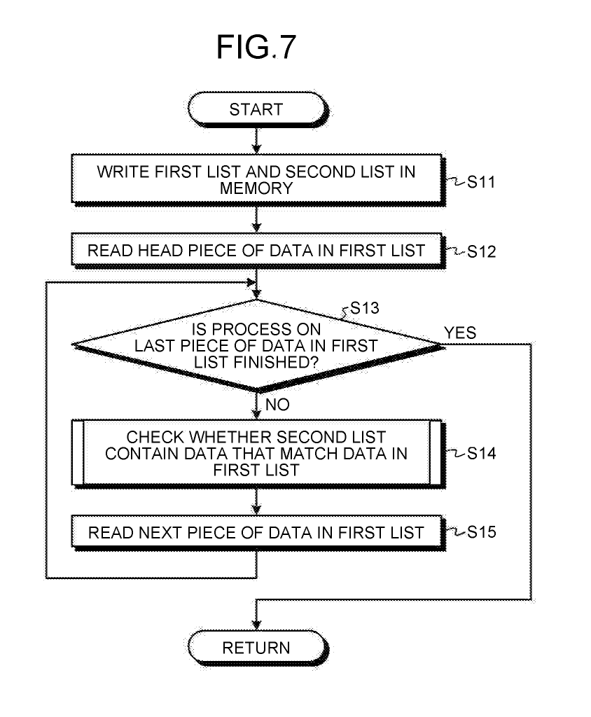

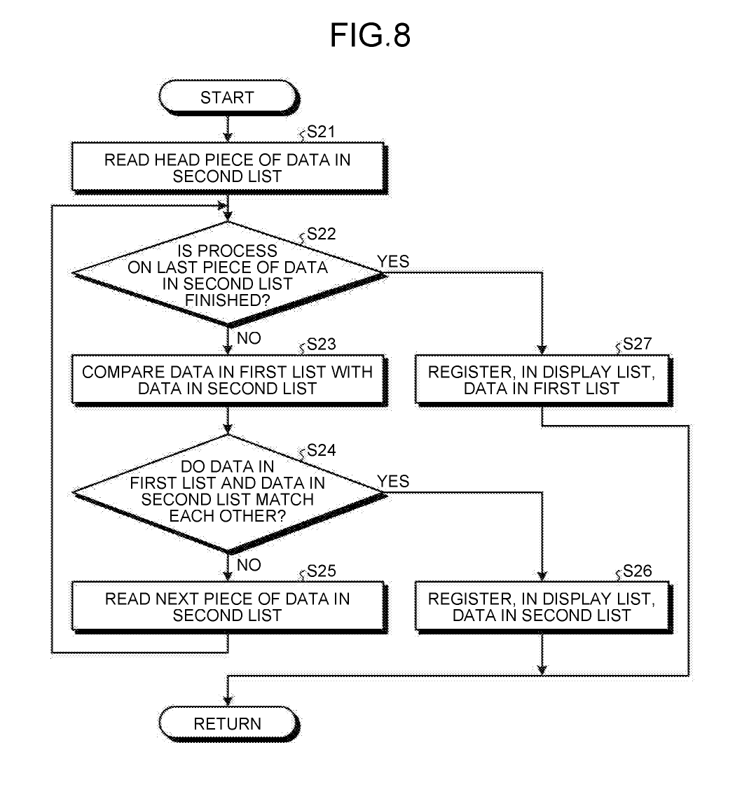

In contrast, at S1, when it is determined that the television device 100 is connected to the network 300, the processing proceeds to S3. At S3, the program guide generator 83 generates the display list 93 on the basis of the first list 91 based on the program information received via the tuner 30, and on the basis of the second list 92 based on the program information received via the network 300. Details of the processing at S3 will be described below with reference to FIG. 7 and FIG. 8, so explanation thereof will not be given here. In the processing flow of FIG. 6, after execution of the processing at S3, the processing ends.

Next, with reference to FIG. 7, the processing performed by the television device 100 to generate the display list 93, that is, the details of the processing at S3 in FIG. 6 will be described below.

In the processing flow of FIG. 7, at S11, the comparator 82 writes, in the memory 90, the first list 91 based on the program information received via the tuner 30 and the second list 92 based on the program information received via the network 300. The processing then proceeds to S12.

At S12, the comparator 82 reads a head piece of data in the first list 91. For example, in the example in FIG. 3, the comparator 82 reads, as a target for comparison, the head piece of data Ch_S(1) in the first list 91. Then, the processing proceeds to S13.

At S13, the comparator 82 determines whether a process on the last piece of data in the first list 91 is finished. Specifically, the comparator 82 determines whether a process at S14 to be described below has been performed on the last piece of data in the first list 91.

At S13, when it is determined that the process on the last piece of data in the first list 91 is not finished, the processing proceeds to S14. At S14, the comparator 82 checks whether the second list 92 contains a piece of data with a channel ID that matches a channel ID of apiece of data in the first list 91. Details of the processing at S14 will be described below with reference to FIG. 8, so explanation thereof will not be given here.

In the processing flow of FIG. 7, after execution of the processing at S14, the processing proceeds to S15. At S15, the comparator 82 reads a next piece of data in the first list 91, that is, a piece of data to be a next target for comparison. For example, if the current target for comparison is the headpiece of data Ch_S (1) in the first list 91, the comparator 82 reads a next piece of data Ch_S(2) in the first list 91 at S15. After execution of the processing at S15, the processing returns to S13.

Meanwhile, at S13, when it is determined that the process on the last piece of data in the first list 91 is finished, that is, when it is determined that the process at S14 on all pieces of data in the first list 91 is completed, the processing returns. Consequently, the processing at S3 FIG. 6 is completed, and the processing ends.

Next, with reference to FIG. 8, processing performed by the television device 100 to check whether the second list 92 contains a piece of data with a channel ID that matches a channel ID of a piece of data in the first list 91, that is, the details of the processing at S14 in FIG. 7 will be described.

In the processing flow of FIG. 8, at S21, the comparator 82 reads a head piece of data in the second list 92. For example, in the example in FIG. 3, the comparator 82 reads, as a target for comparison, the head piece of data Ch_N(1) in the second list 92. The processing then proceeds to S22.

At S22, the comparator 82 determines whether a process on the last piece of data in the second list 92 is finished. Specifically, the comparator 82 determines whether the processing at S23 and S24 to be described below have been performed on the last piece of data in the second list 92.

At S22, when it is determined that the processes on the last piece of data in the second list 92 is not finished, the processing proceeds to S23. At S23, the comparator 82 compares the piece of data serving as the target for comparison in the first list 91 with the piece of data serving as the target for comparison in the second list 92. The processing then proceeds to S24.

At S24, the comparator 82 determines whether the piece of data serving as the target for comparison in the first list 91 matches the piece of data serving as the target for comparison in the second list 92, that is, whether the respective channel IDs match each other.

At S24, when it is determined that the piece of data in the first list 91 and the piece of data in the second list 92 do not match each other, the processing proceeds to S25. At S25, the comparator 82 reads a next piece of data in the second list 92, that is, a piece of data to be a next target for comparison. For example, if the current target for comparison is the head piece of data Ch_N(1) in the second list 92, the comparator 82 reads a next piece of data Ch_N(2) in the second list 92 at S25. After execution of the processing at S25, the processing returns to S22.

In contrast, at S24, when it is determined that the piece of data in the first list 91 and the piece of data in the second list 92 match each other, the processing proceeds to S26. In this case, the second list 92 contains a piece of data with a channel ID that matches a channel ID of the piece of data serving as the current target for comparison in the first list 91. Therefore, at S26, the comparator 82 registers, in the display list 93, the piece of data of the second list 92 that contains a greater amount of information than the piece of data of the first list 91, and then the processing returns. Consequently, the processing at S14 in FIG. 7 is completed, and the processing proceeds to S15 in FIG. 7.

Meanwhile, at S22, when it is determined that the process on the last piece of data in the second list 92 is finished, the processing proceeds to S27. In this case, the second list 92 does not contain a piece of data with a channel ID that matches a channel ID of the piece of data serving as the current target for comparison in the first list 91. Therefore, at S27, the comparator 82 registers the piece of data of the first list 91 in the display list 93, and the processing then returns. Consequently, the processing at S14 in FIG. 7 is completed, and the processing proceeds to S15 in FIG. 7.

As described above, the controller 80 in the embodiment is, by executing the program guide display program 94, configured to: receive first information (the first list 91) on a plurality of first channels via a broadcast signal; receive second information (the second list 92) on a plurality of second channels from the program information server 400 on the network 300; and output a list as the display list 93 when the television device 100 is connected to the network 300 and one or more third channels common to the first channels and the second channels are present. The list comprises: information on programs of the third channels comprised in the second list 92; and information on programs of fourth channels other than the third channels comprised in the first list 91. With this configuration, on the basis of the first list 91, it is possible to generate the display list 93 by using the program information in the second list 92, which has a greater amount of information, with regard to a channel common to the first list 91 and the second list 92. Further, unlike a case in which the display list 93 is output only on the basis of the second list 92, it is possible to prevent program information on a channel that is not actually received as a broadcast signal from being comprised in the display list 93. As a result, it is possible to provide a program list that is more convenient for users.

Further, the controller 80 in the embodiment is configured to output a list as the display list 93 when the television device 100 is not connected to the network 300. The list comprises: the information on the programs of the third channels comprised in the first list 91; and the information on the programs of the fourth channels comprised in the first list 91. With this configuration, even when the television device 100 is not connected to the network 300, it is possible to provide a program list using the first list 91.

Furthermore, the display list 93 in the embodiment further comprises: information to distinguish whether the information on the programs of the third channels is received via the broadcast signal or the network 300; and the information to distinguish whether the information on the programs of the fourth channels is received via the broadcast signal or the network 300. With this configuration, it is possible to easily distinguish whether the information on a program contained in the display list 93 is received via the broadcast signal or the network 300. Meanwhile, the information to distinguish whether the information on a program is received via the broadcast signal or the network 300 is, for example, information on display or non-display of an “*” mark (see FIG. 5) when the display list 93 is displayed as the program guide 500.

Moreover, the controller 80 in the embodiment is configured to display the display list 93 as a two-dimensional program guide, in which the channel information is arranged along one of the row direction and the column direction and the time information is arranged along the other one of the row direction and the column direction. With this configuration, it is possible to provide the display list 93 as a visually clear program guide.

Furthermore, the television device 100 in the embodiment comprises the tuner 30 configured to receive a broadcast signal, and the controller 80 is configured to receive the first list 91 by the tuner 30. Therefore, it is possible to easily acquire the first list 91 by the tuner 30 provided in the television device 100.

Incidentally, the program guide display program 94 in the embodiment is provided as a computer program product in an installable or an executable format. Specifically, the program guide display program 94 may be provided in a state of being included in a computer program product having a non-transitory computer readable medium, such as a CD-ROM, a flexible disk (FD), a CD-R, or a digital versatile disk (DVD).

The program guide display program 94 may be provided or distributed via a network in a state of being stored in a computer connected to the network, such as the Internet. Further, the program guide display program 94 may be provided in a state of being incorporated in a ROM or the like in advance.

Further, in the above description, the television device 100 is described as an example of an “electronic device”. However, a technology of the embodiment may be applied to electronic devices other than the television device 100. For example, a technology of the embodiment may be applied to a portable information processing device, such as a smartphone or a tablet, or a general information processing device, such as a non-portable personal computer (PC). In this case, it is desirable to install a program with the same functions as those of the above described program guide display program 94 in the information processing device. Further, in this case, it may be possible to mount a tuner on the information processing device to acquire the first list, or may acquire the first list from an external device having a tuner by performing communication.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method performed by an electronic device, the method comprising:
receiving first information on programs of a plurality of first channels via a broadcast signal;
receiving second information on programs of a plurality of second channels from a server on a network; and
outputting a list when the electronic device is connected to the network and one or more third channels common to the first channels and the second channels are present, the list comprising information on programs of the third channels in the second information, the list further comprising information on programs of fourth channels other than the third channels in the first information.

2. The method of claim 1, further comprising:
outputting a list when the electronic device is not connected to the network, the list comprising information on the programs of the third channels in the first information, the list further comprising the information on the programs of the fourth channels in the first information.

3. The method of claim 1, wherein the list comprises:
information to distinguish whether the information on the programs of the third channels is received via the broadcast signal or the network; and
information to distinguish whether the information on the programs of the fourth channels is received via the broadcast signal or the network.

4. The method of claim 1, further comprising:
displaying the list as a two-dimensional program guide, in which channel information is arranged along one of a row direction and a column direction and time information is arranged along the other one of the row direction and the column direction.

5. The method of claim 1, wherein
the electronic device comprises a tuner configured to receive the broadcast signal, and
the method comprises receiving the first information by the tuner.

6. An electronic device comprising a hardware processor configured to:
receive first information on programs of a plurality of first channels via a broadcast signal;
receive second information on programs of a plurality of second channels from a server on a network; and
to output a list when the electronic device is connected to the network and one or more third channels common to the first channels and the second channels are present, the list comprising information on programs of the third channels in the second information, the list further comprising information on programs of fourth channels other than the third channels in the first information.

7. The electronic device of claim 6, wherein the hardware processor is configured to output a list when the electronic device is not connected to the network, the list comprising information on the programs of the third channels in the first information, the list further comprising the information on the programs of the fourth channels in the first information.

8. The electronic device of claim 6, wherein the list comprises:
information to distinguish whether the information on the programs of the third channels is received via the broadcast signal or the network; and
information to distinguish whether the information on the programs of the fourth channels is received via the broadcast signal or the network.

9. The electronic device of claim 6, wherein the hardware processor is configured to display the list as a two-dimensional program guide, in which channel information is arranged along one of a row direction and a column direction and time information is arranged along the other one of the row direction and the column direction.

10. The electronic device of claim 6, further comprising a tuner configured to receive the broadcast signal, wherein
the hardware processor is configured to receive the first information by the tuner.

11. A computer program product having a non-transitory computer readable medium including programmed instructions, wherein the instructions, when executed by a computer of an electronic device, cause the computer to perform:
receiving first information on programs of a plurality of first channels via a broadcast signal;
receiving second information on programs of a plurality of second channels from a server on a network; and
outputting a list when the electronic device is connected to the network and one or more third channels common to the first channels and the second channels are present, the list comprising information on programs of the third channels in the second information, the list further comprising information on programs of fourth channels other than the third channels in the first information.

12. The computer program product of claim 11, wherein the instructions cause the computer to further perform:
outputting a list when the electronic device is not connected to the network, the list comprising information on the programs of the third channels in the first information, the list further comprising the information on the programs of the fourth channels in the first information.

13. The computer program product of claim 11, wherein the list comprises:
information to distinguish whether the information on the programs of the third channels is received via the broadcast signal or the network; and
information to distinguish whether the information on the programs of the fourth channels is received via the broadcast signal or the network.

14. The computer program product of claim 11, wherein the instructions cause the computer to further perform:
displaying the list as a two-dimensional program guide, in which channel information is arranged along one of a row direction and a column direction and time information is arranged along the other one of the row direction and the column direction.

15. The computer program product of claim 11, wherein
the electronic device comprises a tuner configured to receive the broadcast signal, and
the instructions cause the computer to perform receiving the first information by the tuner.
